(19) United States
(12) Patent Application Publication
(10) Pub. No.: US 2009/0073724 A1
(43) Pub. Date: Mar. 19, 2009

(54) INPUT DEVICE WITH ILLUMINATION FUNCTION

(75) Inventors: Tsuyoshi Hayama, Miyagi-ken (JP); Hideaki Nagakubo, Miyagi-ken (JP); Koichi Yamamoto, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/268,371

(22) Filed: Nov. 10, 2008

Related U.S. Application Data
(63) Continuation of application No. PCT/JP2007/059764, filed on May 11, 2007.

(30) Foreign Application Priority Data
May 12, 2006 (JP) 2006-134126

(51) Int. Cl. F21V 7/04

(52) U.S. Cl. 362/620

(57) ABSTRACT

An input device having an illumination function includes a wiring board having a predetermined wiring pattern thereon containing a fixed contact point, a light-emitting diode, a planar light-guide plate for guiding emission light from the light-emitting diode in a direction along a surface, a metal dome serving as a movable contact, and a cover sheet having an actuator thereon to be used to press the metal dome. The wiring board is manufactured of a white translucent material. The planar light-guide plate includes a plurality of prism grooves arranged in stripes on the surface thereof, and on a predetermined portion thereof a through-hole for housing the metal dome. An air layer is arranged between the prism bearing surface of the planar light-guide plate and the cover sheet. The metal dome 6 reflects the emission light directed within the through-hole, toward the side of the cover sheet.

This application is a continuation of International Application No. PCT/JP2007/059764, filed May 11, 2007, which claims benefit of Japanese Patent Application No. 2006-134126 filed on May 12, 2006, both of which are hereby incorporated by reference.

### BACKGROUND OF THE INVENTION

1. Field of the Invention

The present invention relates to an input device with an illumination function mounted on a cellular phone or the like and, in particular, to means for uniformly illuminating an entire surface of the input device with a small number of light sources.

2. Description of Related Art

An input device conventionally known as an input device having an illumination function mounted on a cellular phone or the like as shown in FIG. 9 includes a printed board 101 having a predetermined wiring pattern thereon containing a fixed contact point of a push-button switch, a light-guide member 102 arranged on one side of the printed board 101, a plurality of light-emitting diodes 103 arranged on a side face of the light-guide member 102, a dome-shaped metal spring contact 105 serving as a movable contact of the push-button switch housed in a cavity (through-hole) 104 arranged in the light-guide member 102, an elastic sheet 107 having a projection 106 at a portion thereof facing the dome-shaped metal spring contact 105, and a transparent or color translucent push-button section 108 arranged on a portion of the outer surface of the elastic sheet 107 corresponding to the projection 106 on the elastic sheet 107 (for example, see Japanese Unexamined Patent Application Publication No. 2004-356028).

Since the input device having the illumination function causes light emitted from the light-emitting diodes 103 to be guided to the vicinity of the push-button section 108 via the light-guide member 102, and then to be directed in the cavity 104, an operation surface of the push-button section 108 is illuminated by directed light passing through the elastic sheet 107 and the push-button section 108.

### SUMMARY OF THE INVENTION

However, since the input device having the illumination function related to the related art includes a large number of the cavities (through-holes) 104 opened in the light-guide member 102 for housing the dome-shaped metal spring contact 105, it is difficult to guide uniformly the light emitted from the single light-emitting diode 103 over a wide area. To illuminate uniformly the push-button section 108, a plurality of light-emitting diodes (six diodes in the related art) are inevitably needed. For this reason, a variety of problems to be solved arise, for example, the number of components and the number of manufacturing steps are increased, leading to an increase in the manufacturing costs of the device, enlarging the device in size, and resulting in an increased power consumption.

If an EL (Electroluminescence) element is used as a light-emitting body instead of the structure using the light-guide member 102 and the light-emitting diodes 103, all the push-button section 108 is uniformly illuminated. However, an EL element is costly, and tends to generate electromagnetic noise, and is less reliable in terms of long-term use. Furthermore, since a contact portion is operated from above the EL element, the operation feeling of the push-button section 108 is degraded, leading to a further degradation of the EL element.

The present invention has been developed to overcome the above-described problems of the related art, and it is an object of the present invention is to provide an input device having an illumination function that is compact, is manufactured at low costs, and consumes less power.

To overcome the above problems, firstly, an input device having an illumination function of the present invention includes a wiring board having a predetermined wiring pattern thereon containing a fixed contact point of a push-button switch, a light-emitting diode, a planar light-guide plate for guiding emission light from the light-emitting diode in a direction along a surface, a metal dome serving as a movable contact of a push-button switch, and a cover sheet having an actuator thereon for pressing the metal dome, wherein the wiring board includes at least a surface thereof, manufactured of a white translucent material, in contact with the light-guide plate, wherein the planar light-guide plate includes a plurality of prism grooves on either a surface thereof in contact with the wiring board or a surface thereof covered with the cover sheet, each prism groove having a mildly angled slope portion and a steeply angled slope portion steeper in angle than the mildly angled slope portion, and a through-hole for housing the metal dome on a portion corresponding to a formation portion of the fixed contact point, wherein an air layer is arranged between the prism groove bearing surface of the planar light-guide plate and the wiring board or the cover sheet, and wherein the metal dome is housed in the through-hole opened in the planar light-guide plate and has a function of reflecting the emission light from the light-emitting diode, guided through the planar light-guide plate and directed within the through-hole, toward the cover sheet.

If the surface of the wiring board in contact with the planar light-guide plate is manufactured of the white translucent material, an amount of light reflected from the wiring board to the cover sheet is increased, and an amount of wastes of the emission light from the light-emitting diode is reduced. If the plurality of prism grooves are formed in the surface of the planar light-guide plate, light travel to the surface of the planar light-guide plate is uniformized. Furthermore, if the air layer is arranged between the prism groove bearing surface of the planar light-guide plate and the wiring board or the cover sheet, a critical angle of the reflected light in an interface between the planar light-guide plate and the air layer increases. The amount of the light reflected at the interface is increased and the light travel to the surface of the planar light-guide plate is uniformized. Furthermore, if the light having traveled through the planar light-guide plate and having been directed within the through-hole is reflected by the metal dome, a portion corresponding to the through-hole can be illuminated. From these arrangements, a small number of light-emitting diodes can direct light uniformly on the entire surface of the light-guide plate even if the planar light-guide plate having the through-hole arranged therein is used, and the uniformity of the light illuminating the cover sheet is increased. Furthermore, if a plurality of prism grooves are formed on the surface of the planar light-guide plate covered with the cover sheet, the light traveling in the planar light-guide plate is reflected off the prism grooves to the wiring board, and the light is then reflected again from the wiring board to be incident on the cover sheet. In comparison with the case in which the plurality of prism grooves are formed on the surface of the planar light-guide plate in contact with the wiring board, the cover sheet is uniformly illuminated. The prism grooves may be formed in the shape of stripes, arcs, or waves on one surface of the light-guide plate.

Secondly, in the input device having the illumination function in the first arrangement of the present invention, the through-hole is cone-shaped having a slope angle of from 60° to 70°.

With this arrangement, the light having traveled in the light-guide plate is efficiently directed into the through-hole. By reflecting from the metal dome the light having entered the through-hole, illuminance on the portion corresponding to the through-hole is increased.

Thirdly, the input device having the illumination function in one of the first and second arrangements of the present invention includes a positioning unit of the metal dome at the end of the through-hole.

With this arrangement, a position deviation of the metal dome within the through-hole is controlled. Making or breaking the connection of the fixed contact formed on the wiring board with the metal dome is reliably performed, and the reliability of the push-button switch is increased.

Fourthly, the input device having the illumination function in one of the first through third arrangements of the present invention includes on the surface of the planar light-guide plate a light-path modification unit for modifying a path of light traveling in the planar light-guide plate.

Even with the first arrangement, light may not travel uniformly on the portion of the planar light-guide plate where the plurality of through-holes are opened within a close range. If the light path modification unit is arranged on the surface of the planar light-guide plate, the amount of light surrounding the light path modification unit is modified appropriately. The uniformity of light illuminating the cover sheet is increased in a manner free from the number and layout of through-holes.

Fifthly, the input device having the illumination function in one of the first through fourth arrangements includes a linear light-guide plate, arranged on a side face of the planar light-guide plate, for guiding the light emitted from the light-emitting diode in the direction of the side face of the planar light-guide plate.

The use of such a predetermined linear light-guide plate arranged on the side face of the planar light-guide plate eliminates the need for arranging a plurality of light-emitting diodes on the side face of the planar light-guide plate. The number of light-emitting diodes to be arranged is further reduced.

The input device having the illumination function of the present invention includes the wiring board having the surface, manufactured of the white translucent material, in contact with the planar light-guide plate, the planar light-guide plate having the plurality of prism grooves arranged in stripes on the surface thereof, and the air layer arranged on the prism groove bearing surface of the planar light-guide plate so that the light having traveled through the planar light-guide plate and having entered the through-hole is reflected by the metal dome. With this arrangement, a small number of light-emitting diodes can illuminate uniformly the entire surface of the planar light-guide plate, and the uniformity of the light illuminating the cover sheet is thus increased. The reduction in the number of components provides the input device having the illumination function with compact, low-cost and power-saving features.

### BRIEF DESCRIPTION OF THE DRAWINGS

FIG. 1 is an exploded perspective view of the input device having the illumination function in accordance with one embodiment.

FIG. 2 is an exploded side view of the input device having the illumination function in accordance with the embodiment.

FIG. 3 is a sectional view of the input device having the illumination function in the assembled state thereof in accordance with the embodiment.

FIG. 4 is a plan view of a major portion illustrating the structure of a linear light-guide plate and the arrangement of the linear light-guide plate on a planar light-guide plate in accordance with the embodiment.

FIG. 5 is a plan view of the planar light-guide plate in accordance with the embodiment.

FIG. 6 is a sectional view of a major portion illustrating the planar light-guide plate in accordance with the embodiment.

FIG. 7 is a sectional view of a major portion illustrating a wiring board, a light-guide plate, and a metal dome in the assembled state thereof in accordance with the embodiment.

FIG. 8 is a sectional view of a major portion illustrating the light-guide plate and a cover sheet in the assembled state thereof in accordance with the embodiment.

FIG. 9 is an exploded side view of an input device having an illumination function in accordance with the related art.

### DESCRIPTION OF THE PREFERRED EMBODIMENTS

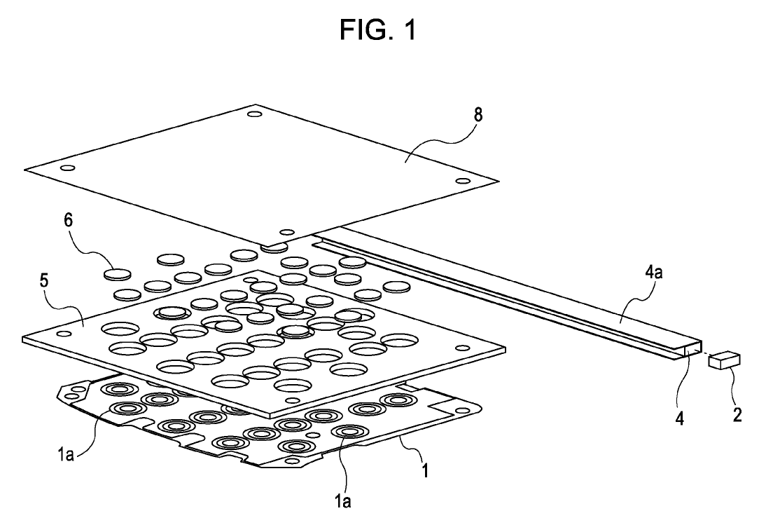

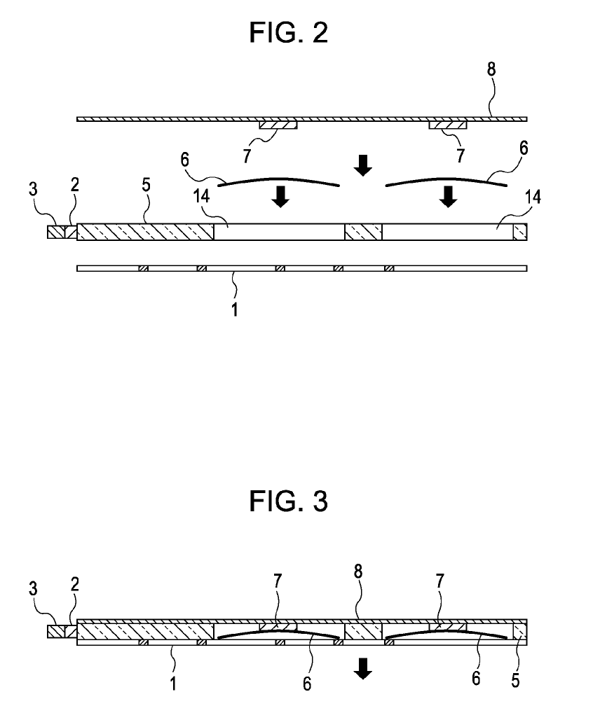

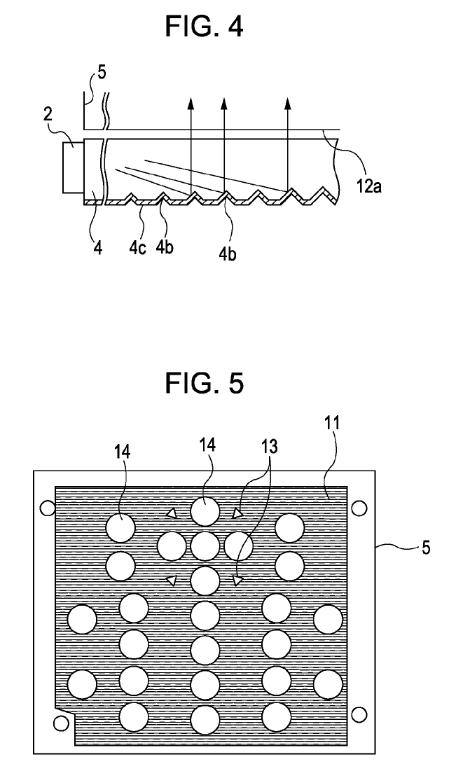

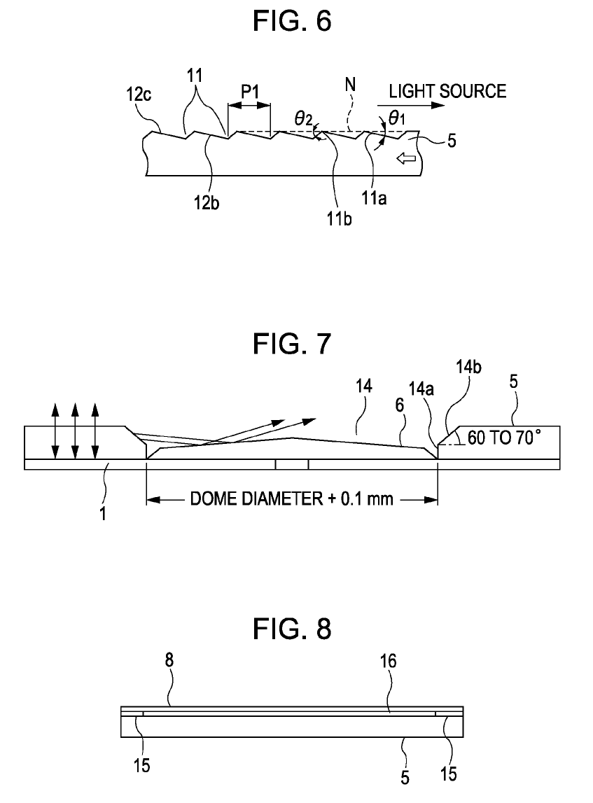

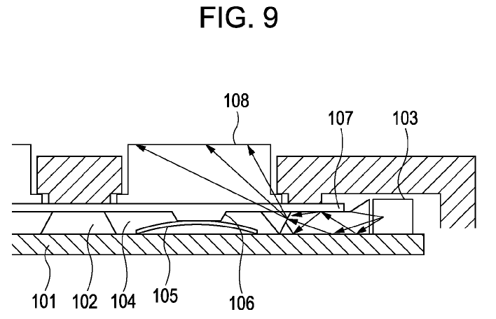

The embodiments of an input device having an illumination function in accordance with the present invention are described with reference to FIGS. 1 through 8. FIG. 1 is an exploded perspective view of the input device having the illumination function in accordance with one embodiment, FIG. 2 is an exploded side view of the input device having the illumination function in accordance with the embodiment, FIG. 3 is a sectional view of the input device having the illumination function in the assembled state thereof in accordance with the embodiment, FIG. 4 is a plan view of a major portion illustrating the structure of a linear light-guide plate and the arrangement of the linear light-guide plate on a planar light-guide plate in accordance with the embodiment, FIG. 5 is a plan view of the planar light-guide plate in accordance with the embodiment, FIG. 6 is a sectional view of a major portion illustrating the planar light-guide plate in accordance with the embodiment, FIG. 7 is a sectional view of a major portion illustrating a wiring board, the light-guide plate, and a metal dome in the assembled state thereof in accordance with the embodiment, and FIG. 8 is a sectional view of a major portion illustrating the light-guide plate and a cover sheet in the assembled state thereof in accordance with the embodiment.

With reference to FIGS. 1 through 3, the input device having the illumination function of the present embodiment includes mainly a wiring board 1 having a predetermined wiring pattern thereon containing a fixed contact point 1a and an unshown wiring, a light-emitting diode 2 arranged at one end of a linear light-guide plate 4, the linear light-guide plate 4 and a planar light-guide plate 5 for guiding emission light from the light-emitting diode 2 in a predetermined direction, a metal dome 6 serving as a movable point of a push-button switch for making and breaking connection with the fixed contact point 1a, and a cover sheet 8 bearing an actuator to be used to press the metal dome 6.

The wiring board 1 has at least one surface in contact with the planar light-guide plate 5 manufactured of a white light-blocking material in order to increase the uniformity of the light illuminating the cover sheet 8 by diffusing the emission light from the light-emitting diode 2. More specifically, a plate entirely manufactured of the white light-blocking material may be used for the wiring board 1, or the wiring board 1 may be formed of a wiring board manufactured of a material other than the white light-blocking material and a cover layer manufactured of the white light-blocking material covering the wiring board. The white light-blocking material may include a reinforced plastic type having as a base material one of liquid-crystal polymer and polyimide, or a rigid type such as glass epoxy or a low-temperature fired ceramic. Furthermore, the wiring board 1 may be a mono-layered structure or a multi-layered structure made of a plurality of layers, as necessary.

The linear light-guide plate 4 guides the emission light from the light-emitting diode 2 in a direction along one side face of the planar light-guide plate 5, and the planar light-guide plate 5 guides the emission light from the light-emitting diode 2 having entered along the one side face of the planar light-guide plate 5 via the linear light-guide plate 4 in the direction of the surface thereof. Each of the linear light-guide plate 4 and the planar light-guide plate 5 is manufactured of a resin material having a high transparency, such as acrylic resin, polycarbonate resin, or cyclic polyolefin by forming one of these materials into a predetermined shape.

Referring to FIG. 1, the linear light-guide plate 4 is mounted to one side face of the planar light-guide plate 5 by means of a holder 4a having a lying U-shape in cross-section. Also referring to FIG. 4, a light output face of the light-emitting diode 2 is arranged to face one end face of the linear light-guide plate 4 with the linear light-guide plate 4 engaged with one side face of the planar light-guide plate 5. An external face of the linear light-guide plate 4, i.e., the side face of the linear light-guide plate 4 opposed to the side face facing the planar light-guide plate 5 has a prism surface on which a plurality of wedge-shaped grooves 4b run in parallel with each other. The light emitted from the light-emitting diode 2 travels within the linear light-guide plate 4 in the direction of length of the linear light-guide plate 4, and is reflected from the inner surface of the wedge-shaped grooves 4b and output toward the side of the planar light-guide plate 5. The wedge-shaped grooves 4b have a greater depth as they are farther from the mounting position of the light-emitting diode 2 so that light is uniformly incident on the side face of the planar light-guide plate 5. The prism surface of the linear light-guide plate 4 is coated with a reflective film 4c being a metal film having a high reflectance made of Al, Ag, or the like. The reflective film 4c increases the reflectance of the prism surface of the linear light-guide plate 5 so that an amount of light incident on the planar light-guide plate 4 is increased. Furthermore, the number of light-emitting diodes 2 is not limited to one. A plurality of light-emitting diodes 2 may be arranged on one end of the linear light-guide plate 4 or one or a plurality of light-emitting diodes 2 may be arranged on opposed ends of the linear light-guide plate 4.

The top surface of the planar light-guide plate 5, i.e., the surface of the planar light-guide plate 5 to be covered with the cover sheet 8 is formed of a plurality of prism grooves 11, each composed of a mildly angled slope portion 11a and a steeply angled slope portion 11b steeper in angle than the mildly angled slope portion 11a as illustrated in FIGS. 5 and 6. The mildly angled slope portion 11a has a smaller angle as it is closer to a light incident portion (the side face bearing the linear light-guide plate 4) 12a, and has a larger angle as it is farther from the light incident portion 12a so that the uniformity of luminance of the cover sheet 8 is increased. Furthermore, the planar light-guide plate 5 reflects light, traveling from right to left as illustrated in FIG. 6, by the steeply angled slope portion 11b toward the side of the wiring board 1, and directs the light reflected from the wiring board 1 toward the side of the cover sheet 8 by the mildly angled slope portion 11a.

A slant angle θ1 of the mildly angled slope portion 11a falls within a range of from equal to or greater than 1° to equal to or smaller than 10° with respect to a reference surface N, and a slant angle θ2 of the steeply angled slope portion 11b falls within a range of from equal to or greater than 41° to equal to or smaller than 45°. With this range, the light traveling within the planar light-guide plate 5 is efficiently directed toward the side of the cover sheet 8. The luminance of the cover sheet 8 is increased while the amount of light emitted from the planar light-guide plate 5 is uniformized in the direction of the surface of the planar light-guide plate 5. If the range of the slant angle θ1 of the mildly angled slope portion is less than 1°, the mean luminance of front light drops, and if the range of the slant angle θ1 of the mildly angled slope portion is more than 10°, the amount of output light within the light-guide plate cannot be uniformized. If the slant angle θ2 of the steeply angled slope portion is below 41° or above 45°, a deviation between the traveling direction of the light reflected from the steeply angled slope portion 11b and the direction normal to the light output surface increases, and the amount of output light from the light output surface, i.e., the luminance of the cover sheet 8 decreases. This is not preferable.

The width of the steeply angled slope portion 11b is larger as the steeply angled slope portion 11b is farther from the light incident portion 12a. Each prism groove 11 is formed so that if the width of the steeply angled slope portion 11b is 1.0 in the vicinity of the light incident portion 12a, the width of the steeply angled slope portion 11b is equal to or greater than 1.1 and equal to or smaller than 1.5 in the vicinity of the opposed end to the light incident portion 12a. With this arrangement, the present embodiment provides the planar light-guide plate 5 excellent in the uniformity of the amount of output light directed to the surface. More in detail, the amount of light traveling within the planar light-guide plate 5 is maximized at the light incident portion 12a, and a portion of the light is output from the light output portion 12b by the prism grooves 11 while the light is traveling within the planar light-guide plate 5. As it is farther from the light incident portion 12a, the amount of light traveling therewithin decreases. In response to the variation in the amount of light inside the planar light-guide plate 5, the planar light-guide plate 5 of the present embodiment varies the ratio of dropping light amount to the amount of light traveling in accordance with the distance from the light incident portion 12a. This arrangement uniformizes the distribution of output light amount within the planar light-guide plate 5, thereby uniformizing the luminance distribution of the cover sheet 8.

It is not necessary to increase the widths of all the adjacent steeply angled slope portions 11b of the prism grooves 11 as the steeply angled slope portions 11b are farther from the light incident portion 12a. The steeply angled slope portions 11b of the prism grooves 11 may be stepwise increased in width by every predetermined number or every predetermined width range.

Furthermore, a pitch P1 of the prism grooves 11 (distance between bottoms of grooves) is constant along the surface. More specifically, the prism grooves 11 are formed in parallel with each other at predetermined intervals. In accordance with the present embodiment, the depth of the prism grooves 11 (a distance between the reference surface N and the bottom of the prism groove 11) remains constant. In this way, the prism grooves 11 have the fixed pitch P1 and the depth. As described above, the prism groove 11 that is farther from the light incident portion 12a of the planar light-guide plate 5 has a wider steeply angled slope portion 11b. The slant angle θ2 of the steeply angled slope portion 11b becomes largest at the prism groove 11 at the side of the light incident portion 12a and gradually decreases as the prism groove 11 is farther away from the light incident portion 12a. It is not necessary that the pitch P1 and the depth of the prism grooves 11 are constant. The prism grooves 11 with these parameters changed still fall within the scope of the present invention. More specifically, with the slant angles θ1 and θ2 of the prism grooves 11 fixed, the width of the steeply angled slope portion 11b may be determined by adjusting the pitch and the depth of the prism grooves 11.

Referring to FIG. 5, as necessary, the planar light-guide plate 5 may include a light-path modification unit 13 for modifying the path of light traveling within the planar light-guide plate 5. The light-path modification unit 13 may be configured in a recess, a through-hole, or a projection, each having any planar shape such as a triangular shape, a square shape, or a polygonal shape. With the light-path modification unit 13 formed in the surface of the planar light-guide plate 5, the amount of light surrounding the light-path modification unit 13 is adjusted. In a manner free from the number and layout of through-holes 14, the light illuminates a portion of the cover sheet 8 corresponding to a portion shadowed by the through-hole 14. The uniformity of light is thus increased.

The planar light-guide plate 5 having a larger thickness makes the output light amount more uniform. For this reason, the thickness of the plate is preferably 0.8 mm or thicker and is more preferably 1.00 mm or thicker. Since in terms of luminance, the planar light-guide plate 5 having a thickness of 1.2 mm or more is not much different from the planar light-guide plate 5 having a thickness falling within a range of 1.0 mm-1.5 mm, the upper limit of the thickness of the plate is 1.5 mm from the standpoint of the flat design of the input device.

The planar light-guide plate 5 includes the through-hole 14 serving as a holder of the metal dome 6 at a position corresponding to the fixed contact point 1a formed in the wiring board 1. As illustrated in FIG. 7, the through-hole 14 includes a positioning portion 14a formed of a straight hole for positioning the metal dome 6, and a light directing portion 14b being a tapered hole shaped in a mortar configuration having a slope angle of from 60° to 70°. The positioning portion 14a has a diameter slightly larger than the outer diameter of the metal dome 6, for example, has a diameter of D+0.1 mm or so where D represents the outer diameter of the metal dome 6. Since this arrangement prevents the metal dome 6 from moving in position within the through-hole 14, the metal dome 6 reliably makes or breaks the connection of the fixed contact point 1a formed on the wiring board 1, thereby increasing the reliability of the push-button switch. The light directing portion 14b has a slope angle of 60°-70° because a simulation test shows that the slope angle of the through-hole 14 set within this range causes the amount of light directed into the through-hole 14 to be maximized.

The metal dome 6 serves as a movable contact point of the push-button switch, and is manufactured by forming a metal plate, such as a stainless plate, into a bowl shape. An electrode contact side (inner side) of the metal dome 6 may be plated with gold or silver, as necessary, to improve electrical connection with the fixed contact point 1a and wear resistance. Also, the outer surface of the metal dome 6 is plated with gold or silver or deposited with aluminum, as necessary, to improve light reflectance. The outer surface of the metal dome 6 may be mirror finished to increase reflectance, or may be satinized to provide diffusion effect.

The cover sheet 8 is manufactured of resin film, such as polyethylene terephthalate, having a high elasticity. The cover sheet 8 may be manufactured of a white translucent material or a transparent material with the surface thereof being light diffusion processed, or a transparent material. If the cover sheet 8 is manufactured of a white translucent material or a transparent material with the surface thereof being light diffusion processed, the light emitted from the light-emitting diode 2 is diffused on the surface of the cover sheet 8. The uniformity of the light illuminating the cover sheet 8 is thus increased. On the other hand, if the cover sheet 8 is manufactured of a transparent material, the amount of light passing through the cover sheet 8 is increased, thereby increasing the luminance of the cover sheet 8. As illustrated in FIG. 8, the periphery portion of the cover sheet 8 is bonded with the periphery portion of the planar light-guide plate 5 by an adhesive layer 15. An air layer 16 having a thickness corresponding to the thickness of the adhesive layer 15 is formed between light output portion 12b of the planar light-guide plate 5 and the cover sheet 8. The air layer 16 arranged between the planar light-guide plate 5 and the cover sheet 8 increases the critical angle of the reflected light at the interface between the planar light-guide plate 5 and the air layer 16. The amount of reflected light at the interface is thus increased, and the light travel toward the surface of the planar light-guide plate 5 is uniformized.

The actuator 7 is designed to press the metal dome 6 and is arranged on a position of one surface of the cover sheet 8 corresponding to a center portion of the step 11 formed on the light-guide plate 4. The actuator 7 may be manufactured of a white light-blocking material or a transparent material. If the actuator 7 is manufactured of a white light-blocking material, an input device having the illumination function selectively illuminating a portion surrounding the actuator results. On the other hand, if the actuator 7 is manufactured of a transparent material, an input device having the illumination function illuminating the entire cover sheet 8 containing the mounting portion of the actuator 7 results.

The input device having the illumination function of the present embodiment is assembled in the procedure described below. More specifically, first, the light-emitting diode 2 is mounted on a predetermined position of the linear light-guide plate 4. The linear light-guide plate 4 is secured to the holder 4a. Furthermore, the actuator 7 is mounted in a predetermined layout on one surface of the cover sheet 8. The planar light-guide plate 5 is positioned and then mounted on the formation surface of the fixed contact point 1a on the wiring board 1. In this way, the fixed contact point 1a formed on the wiring board 1 is arranged in the through-hole 14 opened in the planar light-guide plate 5. The assembling method of the wiring board 1 and the planar light-guide plate 5 may be a bonding method, a snap coupling method, or the like. In succession, the linear light-guide plate 4 is mounted on one side face of the planar light-guide plate 5 by means of the holder 4a. Then, the metal dome 6 with the projected side looking upward is housed in the through-hole 14 of the planar light-guide plate 5. Finally, the cover sheet 8 is bonded to the surface of the planar light-guide plate 5 with the actuator 7 housed within the step 9.

The input device having the illumination function includes the wiring board 1 having the surface, manufactured of the white translucent material, in contact with the planar light-guide plate 5, the planar light-guide plate 5 having the plurality of prism grooves 11 arranged in stripes on the surface thereof covered with the cover sheet, and the air layer 16 arranged on the prism groove bearing surface of the planar light-guide plate 5 and the cover sheet 8 so that the light having traveled through the planar light-guide plate 5 and having entered the through-hole 14 is reflected by the metal dome 6. With this arrangement, a small number of light-emitting diodes can illuminate uniformly the entire surface of the planar light-guide plate 5, and the uniformity of the light illuminating the cover sheet 8 is thus increased. The reduction in the number of components provides the input device having the illumination function with compact, low-cost and power-saving features.

Also in accordance with the above-described embodiments, the plurality of prism grooves 11 are formed in stripes on the top surface of the planar light-guide plate 5, i.e., on the side facing the cover sheet 8. The present invention is not limited to this arrangement. The plurality of prism grooves 11 may be formed in stripes on the underside of the planar light-guide plate 5, i.e., the side facing the wiring board 1.

Also, in accordance with the above-described embodiments, the actuator 7 and the cover sheet 8, produced separately at first, are then attached to each other. The present invention is not limited to this arrangement. For example, a cover sheet with an actuator may be manufactured through injection molding.

Also, in accordance with the above-described embodiments, the light-emitting diode 2 is arranged on the linear light-guide plate 4. The present invention is not limited to this arrangement. The light-emitting diode 2 may be arranged on the wiring board 1 so that light is directly incident on the planar light-guide plate 5.

1. An input device having an illumination function comprising a wiring board having a predetermined wiring pattern thereon containing a fixed contact point of a push-button switch, a light-emitting diode, a planar light-guide plate for guiding emission light from the light-emitting diode in a direction along a surface, a metal dome serving as a movable contact of the push-button switch, and a cover sheet having an actuator thereon for pressing the metal dome, wherein the wiring board includes at least a surface thereof, manufactured of a white translucent material, in contact with the light-guide plate,
wherein the planar light-guide plate includes a plurality of prism grooves on either a surface thereof in contact with the wiring board or a surface thereof covered with the cover sheet, each prism groove having a mildly angled slope portion and a steeply angled slope portion steeper in angle than the mildly angled slope portion, and a through-hole for housing the metal dome on a portion corresponding to a formation portion of the fixed contact point,
wherein an air layer is arranged between the prism groove bearing surface of the planar light-guide plate and the wiring board or the cover sheet, and
wherein the metal dome is housed in the through-hole opened in the planar light-guide plate and has a function of reflecting the emission light from the light-emitting diode, guided through the planar light-guide plate and directed within the through-hole, toward the cover sheet.

2. The input device having the illumination function according to claim 1, wherein the through-hole is cone-shaped having a slope angle of from 60° to 70°.

3. The input device having the illumination function according to claim 1, comprising a positioning unit of the metal dome at the end of the through-hole.

4. The input device having the illumination function according to claim 1, comprising on the planar light-guide plate a light-path modification unit for modifying a path of light traveling in the planar light-guide plate.

5. The input device having the illumination function according to claim 1, comprising a linear light-guide plate, arranged on a side face of the planar light-guide plate, for guiding the light emitted from the light-emitting diode in the direction of the side face of the planar light-guide plate.
